(19) United States
(12) Patent Application Publication
(10) Pub. No.: US 2017/0015247 A1
(43) Pub. Date: Jan. 19, 2017

(54) Side-view mirror cleaning device

(71) Applicant: Thinh V. Nguyen, Pinellas Park, FL (US)

(72) Inventor: Thinh V. Nguyen, Pinellas Park, FL (US)

(21) Appl. No.: 15/209,603

(22) Filed: Jul. 13, 2016

Related U.S. Application Data
(60) Provisional application No. 62/192,374, filed on Jul. 14, 2015.

(51) Int. Cl. B60R 1/06; B60S 1/54

(52) U.S. Cl. CPC B60R 1/0602; B60S 1/54

(57) ABSTRACT

The disclosed mirror cleaning device attaches to a side-view mirror of an automobile. Using a front-facing inlet, the mirror cleaning device takes in air, passes the air through a constriction and deflector/diverter, ultimately discharging the air against the mirrored face of a side-view mirror. The constriction and deflector act to redirect and accelerate the air, allowing the air to more effectively clean the side-view mirror.

### CROSS-REFERENCE TO RELATED APPLICATION

This application is a non-provisional application claiming priority to U.S. provisional application Ser. No. 62/192,374, filed Jul. 14, 2015, the disclosure of which is hereby incorporated by reference.

### FIELD

This invention relates to the field of automotive parts and more particularly to a device for using airflow to clean a side-view mirror.

### BACKGROUND

Vehicle side-view mirrors are critical to safe driving. Such mirrors allow drivers to maintain awareness of surrounding vehicles, allowing for safer lane changes, merging, and awareness of cyclists.

But side-view mirrors are on the outside of the vehicle, subjecting the mirrors to elements and making it difficult for a driver to clean.

Side-view mirrors accumulate condensation when it is humid, water droplets with it is rainy, and dirt when it is dusty. The normal flow of air around a side-view mirror fails to clean the mirrored surface because the air flow separates around the mirror housing. The result is a region of low to no flow that coincides with the mirrored surface. The result is a mirror that cannot clean itself.

It is an object of this invention to provide an inexpensive and reliable device that automatically cleans a side-view mirror using the air through which the vehicle is moving.

### SUMMARY

The disclosed mirror cleaning device attaches to a side-view mirror of an automobile. Using a front-facing inlet, the mirror cleaning device takes in air, passes the air through a constriction and deflector/diverter, ultimately discharging the air against the mirrored face of a side-view mirror. The constriction and deflector act to redirect and accelerate the air, allowing the air to more effectively clean the side-view mirror.

The result is that the mirror cleaning device removes any condensation, mist, rain, or dirt that has accumulated on the mirrored surface. And the device prevents any further build up by continually moving air across the mirror.

For peak effectiveness the vehicle on which the mirror-cleaning device is mounted must be moving at least 25 miles per hour. At this speed, or greater speeds, the mirror-cleaning device quickly removes water and debris. The greater the speed, the stronger the air flow, and thus the more effective the device.

Turning now to the structure of the mirror-cleaning device—two specific features are key to its effectiveness. The first is the constriction that increases airspeed, and the second is the deflector/diverter that changes the direction of the flowing air.

First, the constriction. The constriction within the air flow path of the mirror-cleaning device utilizes the venturi effect. The venturi effect is the reduction in pressure, and corresponding increase in velocity, caused by the flow of a fluid through a constriction within a flow channel.

The velocity of a fluid, here air, increases as it flows through the area of reduced cross-sectional area. The relative sizes of the air inlet and air discharge determine the increase of the speed of the air based on their relative sizes.

The air inlet of the disclosed device has a height and a width. The air discharge of the disclosed device further has a height and a width.

Assuming a constant width, experimental testing has shown that an air intake height of at least three times greater than the air discharge height provides the required air speed to clean the mirrored surface.

Area varies linearly with increases of either height or width. Thus, tripling the height also triples the area. The preferred embodiment includes an air intake with a cross sectional area three times that of the air intake.

Mathematically, the relationship can be shown using equations for fluid flow. Volumetric fluid flow is Q, represented in the equation:

Q=v*A

Where v=flow velocity and A=cross-sectional area. Assuming a constant flow, with two areas, the equation becomes:

Q=vᵢ*Aᵢ=v_{d}*A_{d}

Thus, a decrease in area causes a corresponding increase in velocity, where i is the inlet and d is the discharge.

The above discussion ignores the energy lost as a result of the constriction, and assumes that the speed of the air entering the device is equal to the vehicle speed.

Second, the diverter. With the speed of the air increased, the change in angle of the discharge air is also important to operation of the device.

It is helpful to define flow directions in order to discuss angles. The air inlet takes in air, which is flowing in a direction referred to here as zero degrees. Within the mirror-cleaning device the air is redirected by use of a deflector that changes the flow direction of the air on its way to the discharge. The flow direction of air leaving the discharge is between 70 and 85 degrees offset from the air intake angle, or between 95 and 110 degrees if the supplementary angle is measured. Thus, the diverter changes the direction of the flowing air by a turn more acute than 90 degrees.

The result is that the air is discharged in a direction that is mostly across, but also slightly toward, the mirrored surface of the side-view mirror.

This allows the majority of the velocity of the air to push across the mirrored surface, but with sufficient angle toward the surface to ensure that the air rides along the mirrored surface.

There are additional optional features incorporated into the mirror-cleaning device.

For example, to minimize the quantity of rain entering the air intake tunnel, the length of the upper side of the tunnel can be extended to protrude beyond the length of the lower edge. This forms an air inlet rain overhang. In some embodiments the air inlet rain overhang includes a downward angle to further reduce the amount of incoming rain.

While the air inlet rain overhang will reduce the intake of water, some water will still enter the mirror-cleaning device. A small quantity of rain is of little issue because the velocity generated by the mirror-cleaning device is sufficient to carry the water out the air discharge and past the mirrored surface of the side-view mirror.

Turning to the embodiments of the mirror-cleaning device, three embodiments are illustrated.

The first embodiment is intended for placement on top of a side view mirror. This embodiment is anticipated to fit many types of side view mirrors because nearly all such mirrors include a top surface for mounting. The second embodiment is for bottom mounting. The third embodiment is for side-mounting, likely on the inner side of the side view mirror. The embodiments are discussed in additional detail below.

The preferred embodiment of the disclosed device is an aftermarket product for sale as an add-on. But in other embodiments the device is incorporated into side view mirrors as an integral component.

In order to avoid scratching the paint or plastic of the side view mirror housing, the preferred embodiment of the disclosed device is constructed from plastic.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a view of a first embodiment;

FIG. 2 illustrates a second view of the first embodiment;

FIG. 3A illustrates a schematic view of a generic embodiment;

FIG. 3B illustrates a schematic view of an alternative generic embodiment;

FIG. 4 illustrates a view of a second embodiment;

FIG. 5 illustrates a second view of a second embodiment;

FIG. 6 illustrates a third view of a second embodiment; and

FIG. 7 illustrates a fourth view of a second embodiment.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

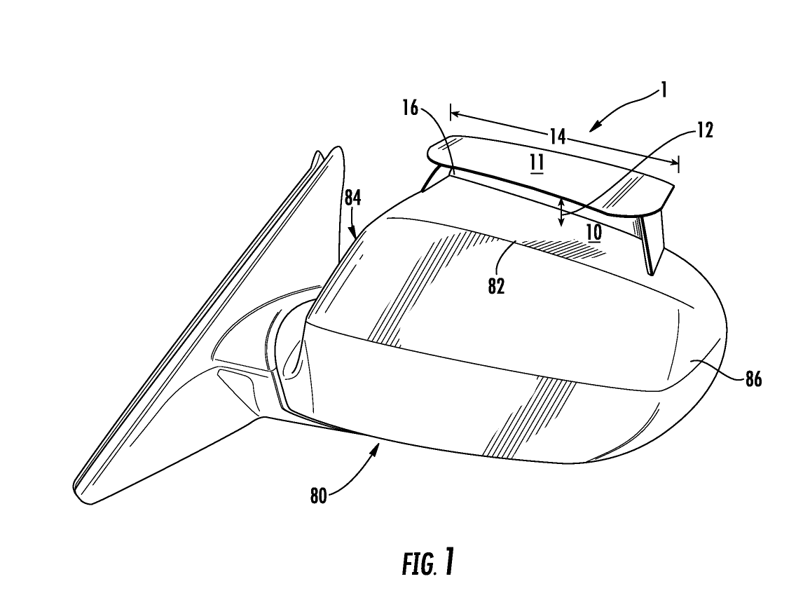

Referring to FIG. 1, a view of a first embodiment is shown with an emphasis on the air intake section of the device. The mirror cleaning device 1 is shown attached to mirror housing top 82 of mirror housing 80. Mirror housing 80 further includes a mirror housing inner wall 84 and a mirror housing outer wall 86.

The mirror cleaning device 1 is comprised of an air inlet 10 for the intake of air that would otherwise pass around the mirror housing 80. Air inlet 10 has a size defined by air inlet height 12 and air inlet width 14, which are used to calculate air inlet area 16.

Also shown is optional air inlet rain overhang 11, which decreases the quantity of water introduced into the air inlet 10.

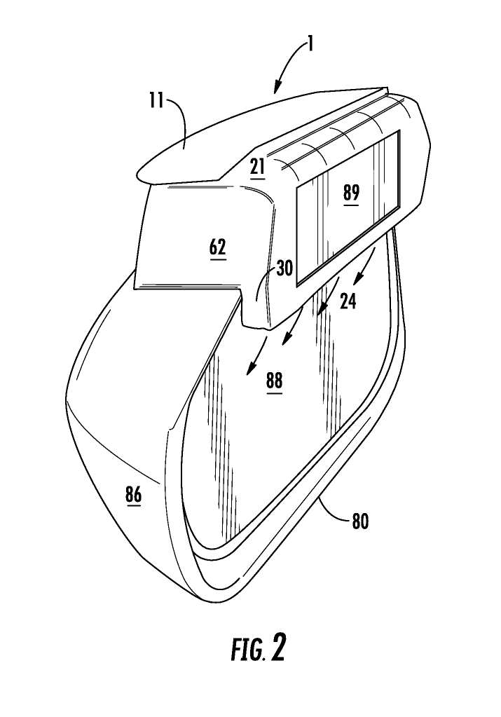

Referring to FIG. 2, a second view of the first embodiment is shown with an emphasis on the air discharge section of the device. Air discharge 30 is shown, with discharged air 24 being forced against the mirror glass 88. The outside of flow diverter 21 is shown, whereby the direction of the flowing air is altered. The result is the air blowing against and across the mirrored face 88 of the mirror housing 80.

Also shown is blind-spot mirror 89, intended to help a driver see areas behind the car that may be missed by the side-view mirror.

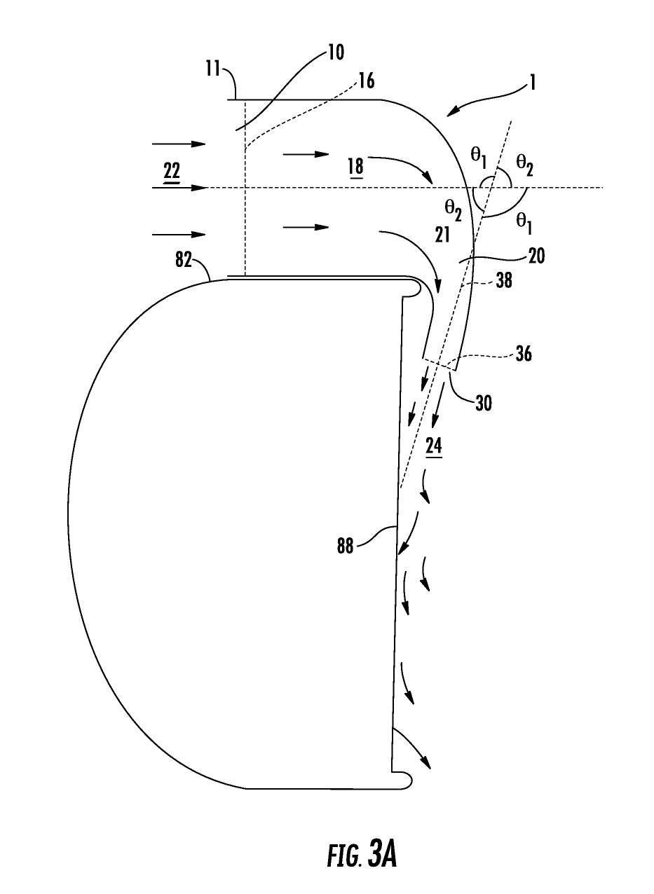

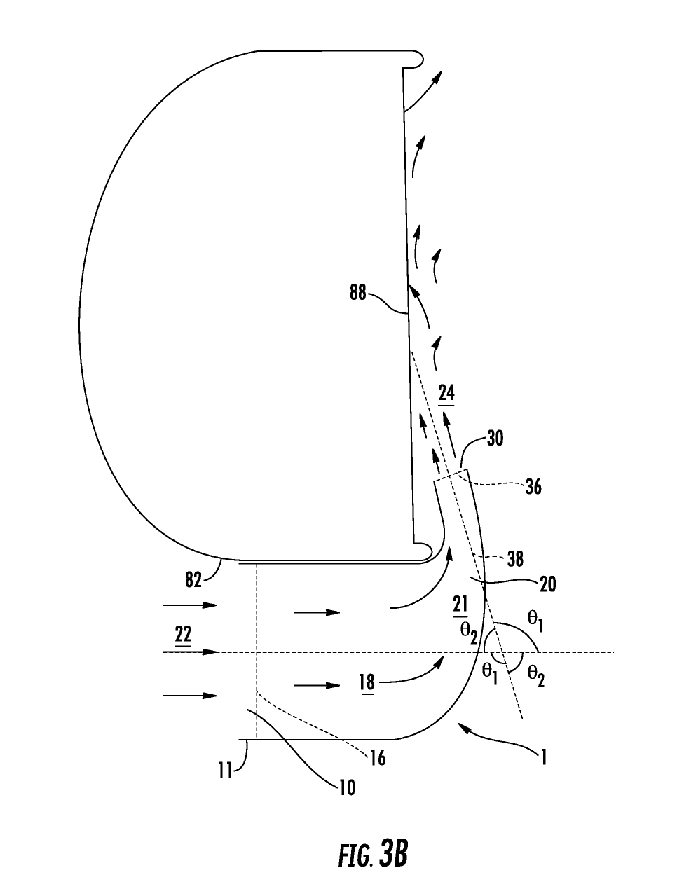

Referring to FIG. 3A, a schematic view of a generic embodiment is shown whereby air flows in across the top of the mirror cleaning device 1.

Mirror cleaning device 1 takes incoming air 22 into air inlet 10. Incoming air 22 flows along air inlet axis 18 defined as perpendicular to air inlet area 16.

As the incoming air 22 moves through the mirror cleaning device 1, it reaches the constriction 20 and flow diverter 21. Constriction 20 reduces the cross-sectional area of the flow path, resulting in an air discharge area 36 that is 33% or less of the air inlet area 16.

Flow diverter 21 changes the direction of the incoming air. Discharged air 24 leaves air discharge 30, which is defined by air discharge height 32 and air discharge width 34, which together are used to calculate air discharge area 36. The flow direction of discharged air 24 is perpendicular to the air discharge area 36, defining air discharge axis 38.

The angle between air inlet axis 18 and air discharge axis 38 is a measurement of the angle by which the incoming air 22 is diverted before becoming discharged air 24. The discharged air 24 contacts the mirrored face 88, removing any water droplets, debris, or other particulates.

These measurements are shown as air inlet and discharge axes outside angle Θ₁ and air inlet and discharge axes inside angle Θ₂.

Air inlet and discharge axes inside angle Θ₁ is between 95 and 110 degrees, resulting in air inlet and discharge axes outside angle Θ₂ being between 70 and 85 degrees.

Referring to FIG. 3B, a schematic view of a generic embodiment is shown whereby air flows in across the bottom of the mirror cleaning device 1. All reference numbers match that of FIG. 3a.

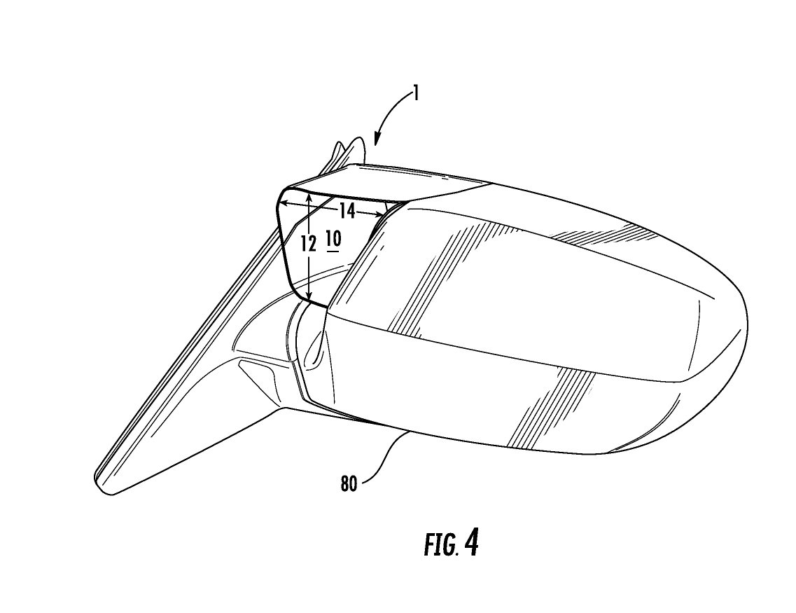

Referring to FIG. 4, a view of a second embodiment is shown. The second embodiment of the mirror cleaning device 1 fits along the mirror housing inner wall 84, avoiding the need for support braces. Air inlet 10 is shown, as well as air inlet height 12 and air inlet width 14.

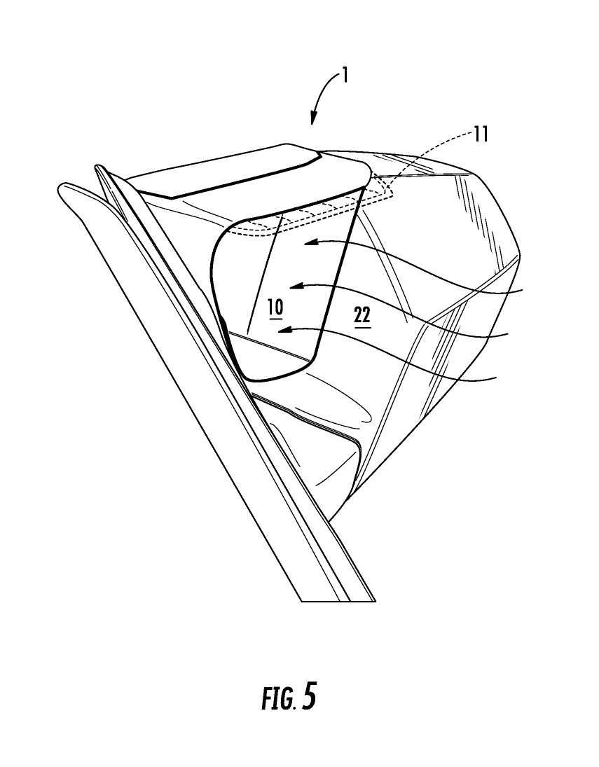

Referring to FIG. 5, a second view of a second embodiment is shown.

Mirror cleaning device 1 is shown with air inlet 10 and incoming air 22. Optional air inlet rain overhang 11 is shown.

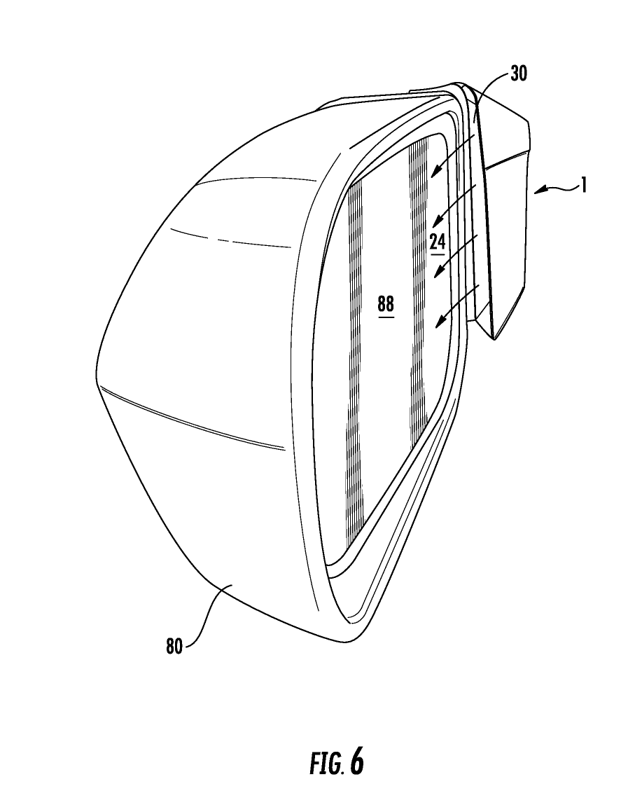

Referring to FIG. 6, a third view of a second embodiment is shown.

Mirror cleaning device 1 is shown with air discharge 30, directing discharged air 24 against mirrored face 88.

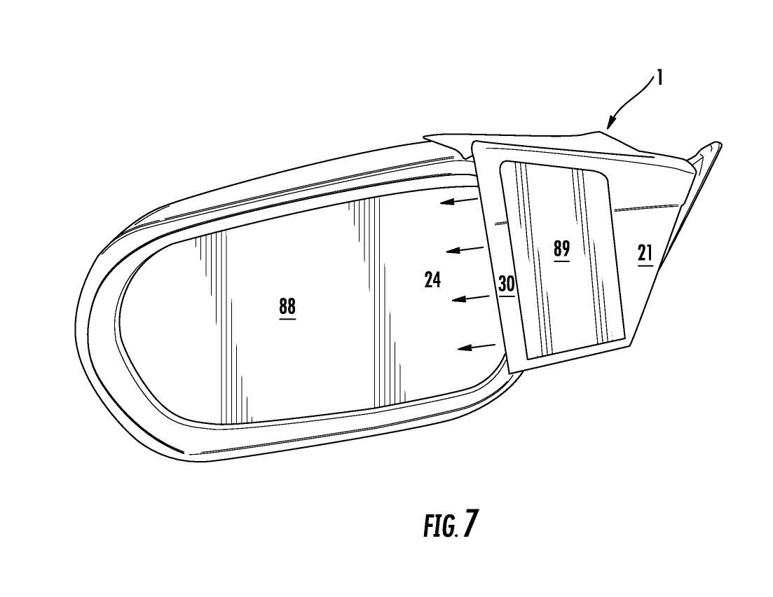

Referring to FIG. 7, a fourth view of a second embodiment.

Mirror cleaning device 1 is shown with air discharge 30, directing discharged air 24 against mirrored face 88. The location of flow diverter 21 is indicated, although this is best shown in the cross-sectional view of FIG. 3.

Also shown is blind-spot mirror 89, intended to help a driver see areas behind the car that may be missed by the side-view mirror.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A device for removing accumulated dirt and water from a mirrored surface of a side-view mirror of an automobile, the device comprising:
a. an air intake to gather air, the air moving into the air intake in a first direction;
b. an air discharge to release the air, the air leaving the air discharge in a second direction;
c. the air intake and air discharge connected by a flow channel;
d. the flow channel including a constrictor and a diverter;
i. the constrictor decreasing cross-sectional area of the flow channel, thereby increasing speed of the air; and
ii. the diverter changing a flow direction of the air, thereby directing the air against the mirrored surface of the side-view mirror.

2. The device of claim 1, wherein the angle between the first direction and the second direction is between 70 and 85 degrees.

3. The device of claim 1, wherein the first direction of the incoming air is moved by an angle of between 95 and 110 degrees before becoming the second direction of the discharged air.

4. The device of claim 1, further comprising:
a. an air inlet rain overhang that protrudes beyond the air inlet;
b. whereby the air inlet rain overhang reduces the quantity of falling water that passes into the air inlet.

5. The device of claim 1, further comprising:
i. a secondary mirror affixed to the device near the air discharge.

6. The device of claim 1, wherein the diverter is the only portion of the device that changes a flow direction of the incoming air prior to the air discharge;
a. thereby avoiding frictional loss that would be caused by additional changes in the flow direction.

7. The device of claim 2, wherein the diverter is the only portion of the device that changes a flow direction of the incoming air prior to the air discharge;
a. thereby avoiding frictional loss that would be caused by additional changes in the flow direction.

8. The device of claim 3, wherein the diverter is the only portion of the device that changes a flow direction of the incoming air prior to the air discharge;
a. thereby avoiding frictional loss that would be caused by additional changes in the flow direction.

9. A device for removing accumulated dirt and water from a mirrored surface using air passing around an automobile, the device comprising:
a. an air inlet having a first area;
b. an air discharge having a second area;
i. the first area at least three times as large as the second area, thereby increasing the speed of the air;
c. the air inlet and air discharge connected by a tunnel;
d. the tunnel changing the direction of the flow of air by between 95 and 110 degrees;
e. whereby the air is directed against a mirrored surface.

10. The device of claim 9, wherein the angle between the first direction and the second direction is between 70 and 85 degrees.

11. The device of claim 9, wherein the first direction of the incoming air is moved by an angle of between 95 and 110 degrees before becoming the second direction of the discharged air.

12. The device of claim 9, further comprising:
a. an air inlet rain overhang that protrudes beyond the air inlet;
b. whereby the air inlet rain overhang reduces the quantity of falling water that passes into the air inlet.

13. The device of claim 9, further comprising:
a. a secondary mirror affixed to the device near the air discharge.

14. The device of claim 9, wherein the diverter is the only portion of the device that changes a flow direction of the incoming air prior to the air discharge;
a. thereby avoiding frictional loss that would be caused by additional changes in the flow direction.

15. A mirror-cleaning device for the removal of water and debris from a side-view mirror, the mirror-cleaning device comprising:
a. an air inlet;
i. the air inlet having an air inlet height and an air inlet width that define an air inlet area;
ii. incoming air passing into the air inlet flowing in a direction along an air inlet axis;
b. an air discharge;
i. the air inlet having an air discharge height and an air discharge width that define an air discharge area;
ii. discharged air passing out of the air discharge flowing in a direction along an air discharge axis;
c. a constriction;
i. the constriction between the air inlet and the air discharge;
ii. the constriction causing the air discharge area to be equal to or less than one-third of air inlet area;
d. a diverter
i. the diverter between the air inlet and the air discharge;
ii. the diverter causing the air discharge axis to be offset from the air inlet axis by an inside angle of between 70 and 85 degrees.
e. whereby the constriction acts to increase the speed of the incoming air and the diverter acts to alter the angle of the incoming air, thus causing the discharged air to remove water and debris from a side-view mirror.

16. The device of claim 15, further comprising:
a. an air inlet rain overhang that protrudes beyond the air inlet;
b. whereby the air inlet rain overhang reduces the quantity of falling water that passes into the air inlet.

17. The device of claim 15, further comprising:
a. a secondary mirror affixed to the device near the air discharge.

18. The device of claim 15, wherein the diverter is the only portion of the device that changes a flow direction of the incoming air prior to the air discharge;
a. thereby avoiding frictional loss that would be caused by additional changes in the flow direction.
